(19) United States
(12) Patent Application Publication
(10) Pub. No.: US 2007/0220594 A1
(43) Pub. Date: Sep. 20, 2007

(54) Software based Dynamic Key Generator for Multifactor Authentication

(76) Inventor: Surendra Kumar Tulsyan, Kennesaw, GA (US)

Correspondence Address: Surendra Kumar Tulsyan, 2404 Heritage Park Circle NW, Kennesaw, GA, 30144, US

(21) Appl. No.: 11/308,060

(22) Filed: Mar. 4, 2006

(51) Int. Cl. H04L 9/32

(52) U.S. Cl. 726/5

(57) ABSTRACT

A software based method and system providing secure and robust multifactor authentication of internet users using at least one factor each of 1) Something you know; 2) Something you have; and 3) Something you are—A physical characteristic of the user or his/her computer/device. This method of authenticating the identity of a user to determine access to a host includes providing an encrypted key string based on one or more static and dynamic factors corresponding the data instances of a user or his/her computer/device, one or more static and dynamic factors corresponding the data instances of the host, and user input factors; evaluating the factor-based data instances to determine if the user's identity is authenticated; and granting or restricting the user's access to the host based on authentication results. The provider generates a key string based on the inputs gathered/provided, time stamps the key, encrypts the key and sends it to the host. The host in turns decrypts the key string, evaluates the static factors against its database, and evaluates the dynamic factors based on pre-defined logic. The user is successfully authenticated if all validations are positive. Based on the authentication results the user is granted or restricted an access to the host resources. This method and system significantly reduces the chances of identity theft occurring from phishing, pharming, man-in-middle theft, spy-ware, and key stroke logger in everyday consumer e-commerce by deploying multifactor authentication based on static and dynamic factors stored/generated at multiple places, key encryption, key time stamping, and elimination of key strokes.

### BACKGROUND OF THE INVENTION

Strong user authentication is achieved through simultaneous presentation of multiple authentication factors, classically defined as:
a) Something you know,
b) Something you have, and
c) Something you are.

Most e-commerce today is based upon weak authentication utilizing only one factor—a password (something you know). Because of the increase of password stealing on the Internet, a wider adoption of multifactor authentication is desirable.

However, multifactor authentication has been difficult and costly to deploy, because it traditionally requires one or many of following
a) Distribution of new device to users, such as a key fob or a smart card and reader.
b) Installation of new software on user's computers, such as a digital certificate, cryptographic key.
c) Installation of hardware like thumb prints reader, retinal scanner, voice scanner, optical scanner, readers, etc. Therefore, the use of multifactor authentication has been limited to a relatively small number of very high-value relationships and transactions.

Individuals must present credentials to demonstrate that they are who they claim to be. These credentials are varied, and fall into three types, often referred to as authentication factors:
a) Information (“Something You Know”)
   Example—Password, PIN, zip code, phone number, Social Security number, account number, mother's maiden name, recent transactions, secret question & answer, credit history, etc.,
b) Object (“Something You Have”)
   Example—Credit card, driver's license, ID card, passport, smart card, contact less card or key fob, dynamic password generator, phone, PDA, computer, peripheral, Digital certificate, key, etc.,
c) Person (“Something You Are”)
   Example—Photograph, signature, fingerprint, retinal scan, hand geometry, facial geometry, voiceprint, Device Id, DNA analysis, etc.

These credentials can be physically or electronically stolen, counterfeited, or replicated. Use of multiple credentials of different types can increase security. Multiple credentials of the same type offer less increased security than credentials of different types, because they can often be misappropriated at the same time in the same way.

In face-to-face interactions, credentials of all three types of factors can be directly inspected. However, in remote interactions such as those done over the Internet, credentials which are objects or persons cannot be directly inspected. So their presence and authenticity should be verified in some other way. Typically, this is done by accessing some unique data stored on the object (such as the data encoded on a magnetic card) or by taking some measurement of the object or person (such as the fingerprint of a person). To prevent the fraudulent replay of such data, some systems employ dynamic data or a cryptographic challenge-response.

Systems which utilize objects or persons as authentication factors in remote electronic authentication generally require one or more of the following: (1) new software installed on the user's computer such as digital certificate, (2) new hardware such as a reader attached to the computer, and/or (3) a hardware device, such as a smart card or a key fob, distributed to users.

Given that a user accesses many different hosts requiring identification, devices/software like key fob, smart card, digital certificate, cryptographic key have to be distributed by each of these hosts to the user. Carrying them or installing multiple such devices/software is too inconvenient, difficult, and confusing users. Thus, this is not a practical option.

Given that a user may access these hosts from different computers, attaching devices like scanners, readers to multiple computers or carrying them is difficult and costly to operate. Thus, again this is not a practical option. Similarly, installation of software like digital certificate also pose similar problem.

The complexity of the above two further increases by many folds when different hosts adopt different methods or technologies for authentication.

Most of the multifactor technologies available in the market address only one or few of many ways of identity theft like spy-ware, key-logger, phishing, pharming, man-in-middle attack, etc.

Due to complicate nature of many of the currently available multifactor technologies there is a tendency of developing “identity sharing syndrome” where a user shares his/her identity with someone else and requests the other person to access his/her information on his/her behalf.

Most of the multifactor technologies available in the market require users to remember user-ids. These user-ids can be user's name, account number, social security number, generated id from names, e-mail id, randomly generated id, etc. Given that a typical user accesses many web sites and each web site may have different ids, it becomes very difficult for the user to remember user-ids. This may lead to keeping the same user-id (for e.g. e-mail id) for all web-sites, provided web sites permit it.

Most of the multifactor technologies available in the market require users to remember additional factors. Given that a user can not even remember password for many sites, it will be further difficult for him/her to remember additional information. This may lead to keeping the same password and same additional information for many web-sites.

Because of the tendency of keeping the same user-id and password, it becomes very easy for a hacker to steal this information and misuse them.

Most of the multifactor technologies available in the market require distribution of devices/software, etc. Or they expect users to have costly devices like scanner, readers, cell phone, etc. These limit users from using them when they are traveling. Also, there is a big “loss time” when these devices are being replaced.

Most of the multifactor technologies available in the market are very costly for a common person. They require very high initial investment and recurring costs.

Multifactor authentication responsibility can be given to one single independent agency responsible for authentication for multiple hosts. But, this option is too risky because
a) The host may loose the control over authentication
b) A failure or breach of security on the agency part can affect many hosts
c) Confidential user data may have to be shared with the agency
d) Risk of data leak from the agency to the competitors or other parties
e) Staff of the agency may have the full control of data and can misuse it
f) A single hacking of the agency site/computer/database can impact many businesses
g) User interface can shift from the host to the independent agency, thus resulting in an adverse business impact for the host.

What is needed is a system and process having features—
a) Authenticating the identity of a user to determine access to a host based on multiple factors using at least one factor each of 1) Something you know; 2) Something you have; and 3) Something you are—A physical characteristic of the user or his/her computer/device,
b) Performing of multifactor authentication that can be deployed requiring minimum software or hardware that a typical user and organization may already possess,
c) A simple to use client based or web based client component that does not require specialized hardware or software,
d) The client based software that may be available as a client GUI based application, applet, service, or web initiating application,
e) The server based authentication engine software that is running on host computer using a database/file system,
f) Each of this software or hardware can be used as a common authentication method for multiple hosts,
g) Each of this software or hardware can be used from multiple user's computers,
h) Allowing user to use the software anywhere from the world,
i) Allowing user to securely store user-ids and optionally passwords for registered hosts,
j) Allowing user to use the stored user-id and password,
k) Allowing multiple users to use the same piece of software/hardware installed on a computer for authenticating with multiple hosts,
l) Software that does not require replacement, in case of device loss. Thus, eliminating “loss time”,
m) Software that discourages “identity sharing”,
n) A dynamically generated key string having very short life and it keeps changing. Thus, even if it is stolen, it can not be used when the life is over,
o) A key string generated using at least one factor value, based on “Something you know” like password, PIN, zip code, phone number, Social Security number, account number, mother's maiden name, etc. Thus, user has a control on factors only he/she knows,
p) A key string generated using at least one static or dynamic factor value, based on “Something you have”. A static factor is like handle given by a host to a user. This handle can be given during a registration process. The handle can be stored locally on the user's computer or known to the user. These factors could be used for trusting between the user's computer and the host. Dynamic factors can be like host computer's time, session id allocated by the host, transaction id allocated by the host, or any other dynamic seed value allocated by the host. These dynamic factors can be obtained by the client software component from the host server software component during a handshake. These are not stored anywhere but used for trusting between user's computer and the host server,
q) A key string generated using at least one static or dynamic factor value, based on “Something you are”. Static factors can be either user's computer property like disk id, MAC id, hardware id, CPU id or user's physical characteristics like biometric information. Alternatively, they can be other information like digital certificate, key, normally stored on user's computer. These factors are stored in host server database during the initial registration process. They are used for trusting between user's computer and the host server. Dynamic factors are like user computer's clock time, IP address. These factors are not stored but used for trusting between user's computer and the host server based on pre-determined logic,
r) An encrypted key string, so man-in-middle attack becomes difficult,
s) Users do not have to key-in the key string. But it can be passed using actions like copy & paste or drag & drop. This eliminates theft by spy-ware and key logger software. Alternatively, the key string is passed to the web-site without a user triggered action,
t) Both data stored on the user's local computer and host computer is secured and protected. Thus reducing the probability of leakage of data either on user end or host end,
u) A simple interface that accepts the key string and passes on to the host for authentication,
v) A server software running on host computers that accepts the key string value; builds the encryption key based on data stored, decrypts the key string based on the encryption key, evaluates the static factors against its database, and evaluates the dynamic factors based on pre-defined logic,
w) Allowing or denying the access to the host based on the authentication results.

### SUMMARY OF INVENTION

The present invention discloses a software based secure, robust, flexible, usable, economical, and auditable single method that can reduce chances of identity theft occurring from phishing, pharming, man-in-middle theft, spy-ware, and key logger theft in everyday consumer e-commerce. This is achieved by deploying multifactor authentication based on static and dynamic factors stores/generated at multiple places. Thus, this single software based system makes multifactor authentication practical for widespread use.

The present invention is implemented using a client or web-based client software and corresponding server software. The client software component residing on user's computer generates an encrypted key string based on user inputs and static/dynamic stored/gathered factors. These static and dynamic factors identify the user, source computer and destination host. This generated key string has a very limited life. The automatic generation and dragging/copying of key string to the target web site further avoids key strokes. It becomes very difficult to steal the identity of a user because of dynamically generated encrypted key string based on multiple static and dynamic factors having knowledge of user, source computer, destination and host. The spy-ware/key logger theft is further eliminated by avoiding key strokes. Encryption makes further difficult for man-in-middle attack. Client component may be available as a client GUI based application, applet, service, or web initiating application.

The present invention is implemented using corresponding server based authentication engine software that decrypts the sent key and validates passed factors based on pre-determined logic and/or against factors stored in its database. This server component is hosted on host's servers.

Although in this document an example of logon to a host using a web site is taken, but the method and system disclosed herein are capable of a secure multifactor logon using a non-browser based logon mode. So, the present invention should not be considered restrictive to web based logon.

As will be appreciated, the method and system disclosed herein are capable of other and different embodiments, and capable of modifications in various respects. Accordingly, the drawings and description set forth herein are to be regarded as illustrative in nature and not restrictive.

### BRIEF DESCRIPTION OF THE DRAWINGS

FIG. 1 represents a flow chart of registration process defined in presently invented Dynamic Key Generator for multifactor authentication.

FIG. 2 represents a flow chart of key generation and authentication process defined in presently invented Dynamic Key Generator for multifactor authentication.

### DETAILED DESCRIPTION OF A PREFERRED EMBODIMENT

The present invention is a method and system that can be implemented either using a client/server version of software component that can run on any standard OS like Windows, Linux, Mac or using a web-browser based software (like applet). It does not require any specialized hardware or software to run. Client component can be implemented as one or many forms like client GUI based application, applet, service, or web initiating application.

The present invention is a method and system that extends authentication process for commonly used authentication—user-id and password.

The present invention is a method and system that may require users to install client component of the Dynamic Key Generator software on his computer.

The present invention is a method and system that requires hosts to install authentication engine component of the Dynamic Key Generator software on their servers.

The present invention is a method and system that expects users to have access to standard web browsers like Internet Explorer, Netscape, etc. which anyhow they should have for accessing e-commerce web sites.

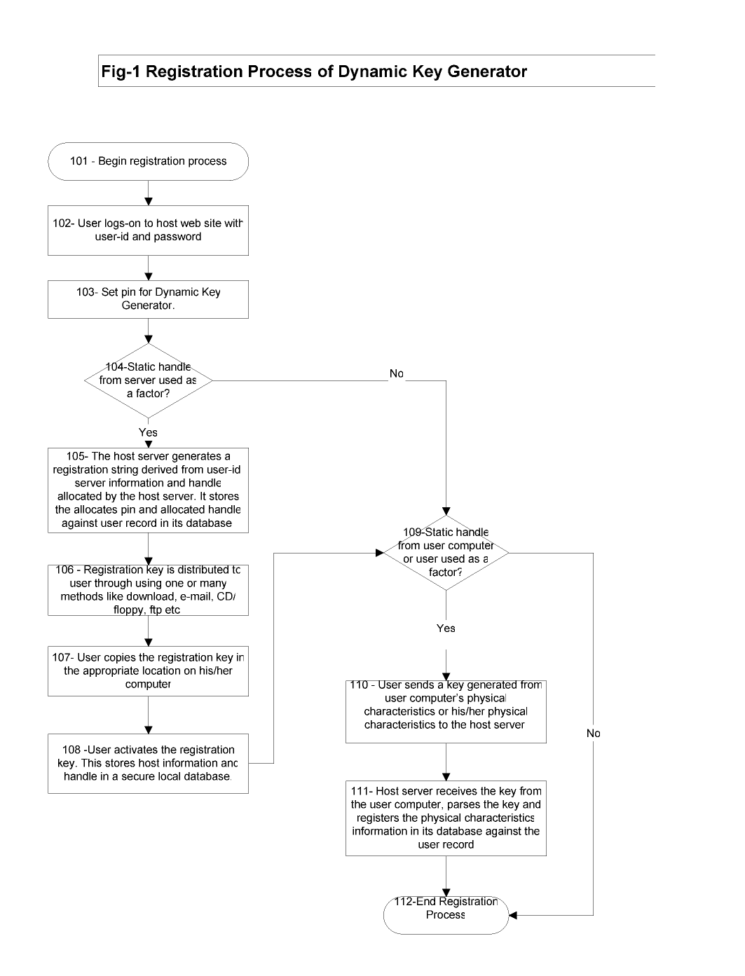

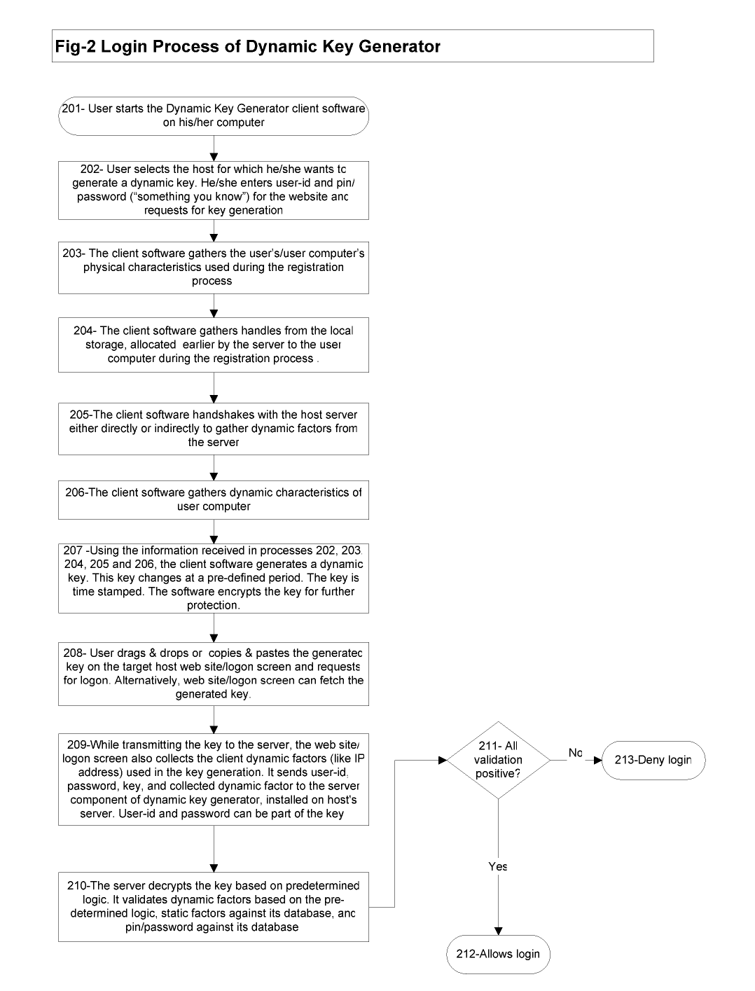

FIG. 1 and FIG. 2 show block diagrams of dynamic key generation system defined in the present invention.

FIG. 1 shows block diagram where a user can register itself and its computer with a host.

FIG. 1 Block 101—is a process that marks begin of registration process.

FIG. 1 Block 102—is a process indicating a user logging-on to a host web site from anywhere in the world over the internet for registering with a host. He/she enters his user-id and regular password of the host. Here password is one factor of type “Something you know”.

FIG. 1 Block 103—is a process indicating that if the user is not yet registered with the host, the server component of the host requests the user to set-up a pin for Dynamic Key Generator. This pin is treated as a second factor of type “Something you know”. The pin can be zip code, phone number, Social Security number, account number, mother's maiden name, or any other code that only user should know. The server component checks the pin and if found valid stores it against the user record in its database in a secure format.

FIG. 1 Block 104—is a process checking whether host is set-up for allocating a static factor to users.

FIG. 1 Block 105—is a process showing that if host is set-up for allocating a static factor to users, it generates a registration key with handle information. This handle is considered as a static factor of type “Something you have”. A handle can be made of physical characteristics of the server and a unique seed value per user computer. Thus making this handle unique to a user computer and a host. This handle is used for trusting between the user's computer and the host server. Using a similar process multiple handles based on independent factors can be generated and distributed to the user.

FIG. 1 Block 106—is a process showing that the registration key is distributed electronically to the user through download, e-mail, CD/floppy, ftp, etc.

FIG. 1 Block 107—is a process showing that the user copies the registration key in an appropriate directory on his/her computer.

FIG. 1 Block 108—is a process showing that the user activates the registration key. During activation, this handle information stored either on user's computer or some network computer in a secure format.

FIG. 1 Block 109—is a process checking whether host is set-up for accepting static factor from users.

FIG. 1 Block 110—is a process showing that if host is set-up for accepting a static factor from users, user sends a key generated based on the physical characteristics of the user's computer and/or his/her physical characteristics. This is considered as a static factor of type “Something you are”. The key uniquely identifies the user and/or user's computer. Computer's characteristics are like Mac-id, hardware-id, CPU id, disk-id, etc. User's characteristics are like biometric information, finger print, etc. This factor is used for trusting between the user's computer and the host server. Using a similar process multiple independent factors can be generated and registered with the host.

FIG. 1 Block 111—is a process showing that host accepts the key sent by the user, parses it and stores the factors in its secure database against the user record. Thus, a trusting relationship is built between the server and user's computer.

FIG. 1 Block 112—is a process that marks end of registration process.

User can repeat the process detailed in FIG. 1 for registering all the computers from which he/she wants to access the host.

FIG. 2 represents a block schematic diagram of authentication process defined in presently invented authentication system.

FIG. 2 Block 201—is a process that marks begin of logon process. If user is using the client component, he/she starts the client component of dynamic key generator on his computer. Otherwise, if user is using web browser based dynamic key generator, he/she opens an appropriate page and brings-up dynamic key generator. User opens the logon page of the host web site he/she wants to logon.

FIG. 2 Block 202—is a process that shows that user selects the web site he/she wants access, enters user-id & password/pin, and requests for key generation.

FIG. 2 Block 203—is a process that shows that the client software gathers the user's/user computer's physical characteristics used during the registration process.

FIG. 2 Block 204—is a process that shows that the client software gathers handles from the secure storage, allocated earlier by the host server to the client during the registration process. In case of a client version of dynamic key generator the data is typically stored on user's computer. But, in case of an applet version, it is stored with a centralized remote computer. All or many users can store their information on this centralized remote computer.

FIG. 2 Block 205—is a process that shows that the client software handshakes with the host server either directly or indirectly to gather dynamic factor allocated by the server. They can be host server's time, session id, transaction id, or some other seed value.

FIG. 2 Block 206—is a process that shows that the client software gathers dynamic characteristics of user computer. They can be IP address, user computer's time, etc.

FIG. 2 Block 207—is a process that shows that using the information received in processes 202, 203, 204, 205 and 206, the client software generates a dynamic key. This key changes at a pre-defined period, normally after every few seconds. The key is time-stamped. The client software encrypts the key for further protection.

FIG. 2 Block 208—is a process that shows that the user drags & drops or copies & pastes the generated key on the target web site and requests logon. Alternatively, web site can fetch the generated key without any user triggered action.

FIG. 2 Block 209—is a process that shows that while transmitting the key to the server, the web site also collects the client dynamic factors (like IP address and clock time) used in the key generation. It sends user-id, key, and collected dynamic factors to the server component of dynamic key generator, installed on host's server.

FIG. 2 Block 210—is a process that shows that the server authentication engine decrypts the key based on predetermined logic and carries out the following validations.
a) It checks that the dynamic user's factors passed as part of the key match (detailed in FIG. 2 206) with dynamic factors collected during the transmission (detailed in FIG. 2 209). For example IP address should match; clock can differ only by a small acceptable delta. Any mismatch in IP address or unacceptable difference in the clock time indicates a potential use of the key from some other computer, indicating phishing and pharming.
b) It checks that the dynamic server factors passed as part of the key match with dynamic factors allocated during the handshake (detailed in FIG. 2 205). This is validated based on pre-determined logic. For example session id in the key should match with session id allocated during the handshake. Any mismatch indicates a potential use of the key from some other computer, indicating phishing and pharming.
c) It checks that the static user's factors passed as part of the key (detailed in FIG. 2 203) match with factors stored against user record in the host server database. For example Mac-id in the key should match with Mac-id registered with the host server. Any mismatch indicates possible man-in-middle attack of key and misusing from any other computer.
d) It checks that the static server's factors passed as part of the key (detailed in FIG. 2 204) match with factors stored against user record in the host server database. For example handle in the key should match with the handle recorded in the host server database. Any mismatch indicates possible hacking of key and misusing from any other computer.
e) It checks that the password/pin passed as part of the key (detailed in FIG. 2 202) match with password/pin stored against user record in host server database. Any mismatch indicates a potential man-in-middle attack.

FIG. 2 Block 211—is a process that shows that the authentication engine is checking whether all validations carried out in process 210 are valid.

FIG. 2 Block 212—is a process that shows if all validations are positive, the user is allowed to logon.

FIG. 2 Block 213—is a process that shows if all validations are not positive, the user is denied access.

Although processes 201-213 takes an example of logon to the host using a web site, the method and system disclosed herein are capable of a secure multifactor logon using a non-browser based logon mode using similar processes.

Not shown in FIG. 1 and FIG. 2, the client software allows users to securely store user-id and optionally password/pin on user's computer. Thus, users do not have to remember user-ids, password, pin for many hosts and they do not have to keep same user-id, password, or pin for many hosts.

Thus, the present invention is highly secured because:
a) It uses multiple independent factors of all three types. A hacker can successfully logon to a user account only if all static factors are stolen from different points, key is successfully decrypted, dynamic factors are extracted, factors are modified, new key based on modified factors is generated and used within a short time window. The probability of trapping all factors and using within a short time window is extremely low.
b) The static factors are stored at different locations. So hacking on any one location will not reveal the full identity a user.
c) The dynamic factors like IP address and time are not stored anywhere. This makes difficult for any hacker to obtain this information and use it.
d) Two factors (password & pin) are known only to users.
e) Key generated using multiple factors is stamped with expiry time. Thus, a short life is defined for the key. This makes authentication more secure as key becomes unusable after it expires.
f) The whole key string is further encrypted. This makes very difficult to hack, decrypt the key and extract the information. Thus, man-in-middle attack becomes useless.
g) Since IP address and user's computer address is part of the key, an authentication request from any attempt computer using this key will not be successful. Thus, a key is protected from phishing and pharming attacks.
h) Key strokes are eliminated by entering the key on the target web-site using copy & paste or drag & drop. Thus, a key can not be trapped by spy-wares and key loggers.
i) Since static factors are registered and stored both on the client computer and server, a trust relationship is defined between them. Thus, any authentication attempt will require these static factors to match. This makes very difficult for anybody to attempt a successful logon from any unregistered computer even if the password/pin is stolen. Thus, this makes phishing, pharming, and man-in-middle attack very difficult.

Thus, the present invention requires minimum software to be deployed on user's computers. It does not require any special software or hardware. Using the same software a user can generate keys for accessing many hosts.

Thus, the present invention is implemented using standard web browser based or client based software. It does not require any special software or hardware. Since it is a software based solution, users do not have to carry any hardware/device for authentication.

Thus, the present invention allows the same software as a common authentication method for multiple hosts. This single software can be used for multiple hosts. Hence, it is more economical and convenient.

Thus, the present invention allows a multiple users to use the same software on a computer. Thus, each user does not have to carry different software/hardware.

Thus, the present invention allows this software to be installed on different user computers. Thus, users can access a web site from many computers, anywhere from the world.

Thus, the present invention does require users to carry anything. Users can simply download the client component, register the computer and use it. This eliminates “loss time” typically involved when devices are being replaced.

Thus, the present invention reduces the chances of “identity sharing” as there is no “loss time”. “Identity sharing” typically happens when a user does not have access to the device and he/she requests someone else to access his account on his/her behalf by sharing his identity.

Thus, the present invention allows multiple factors of type “Something you know”, like password and PIN.

Thus, the present invention allows multiple static factors of type “Something you have”—like server handle. This type of factors helps in building a trusted relationship between the user's computer and host server. This makes very difficult for anybody to attempt a successful logon from a computer without handle information, even if the password/pin is stolen. In such case, the key would get rejected because the computer would not have been registered and activated with the host server. Thus, this trusted relationship makes phishing, pharming, and man-in-middle attack very difficult.

Thus, the present invention allows multiple dynamic factors of type “Something you have”—like server clock, session id, transaction id. These factors are dynamic and not stored anywhere. If a key stolen and attempted from any other computer at a later time, the key would get rejected because the computer would not have the knowledge of the dynamic factors used in the key. Thus, this makes phishing, pharming, and man-in-middle attack very difficult.

Thus, the present invention allows multiple static factors of type “Something you are”—like hardware id, disk id, Mac id of the user's computer or physical characteristics of user. Again, this type of factors helps in building a trusted relationship between the user's computer and host server. Again, this makes very difficult for anybody to attempt a successful logon from an unregistered computer, even if the password/pin is stolen. In such case, the key would get rejected because the computer would not have been registered with the host server. Thus, this trusted relationship makes phishing, pharming, and man-in-middle attack very difficult.

Thus, the present invention allows multiple dynamic factors of type “Something you are”—like IP address, user computer's clock. These factors are dynamic and not stored anywhere. If a key stolen and attempted from any other computer at a later time, the key would get rejected because the computer would not have the knowledge of the dynamic factors used in the key. Thus, this makes phishing, pharming, and man-in-middle attack very difficult.

Thus, the present invention allows transferring of generated key from the dynamic key generator software to the web site is using copy & paste and drag & drop. Because of this method it becomes very difficult for a spy-ware and key logger software to trap the key.

Thus, the present invention allows a registration process during that static factors are registered and stored securely both in user database and in server database. These factors are used for trusting at the time of authentication.

Thus, the present invention defines a registration process that can be repeated for registering multiple user computers. Thus, a user can register many computers with a host and use these registered computers for accessing host web sites.

Thus, the present invention defines a registration process that can be used by multiple users using the same computer. This is achieved by giving unique handle given by the server to a user and a computer.

Thus, the present invention defines a process where data is stored securely in user's database. This secure database makes the leakage of factors very difficult at the user end.

Thus, the present invention defines a process where data is stored securely in host server database. This secure database makes the leakage of factors very difficult at the host end.

Thus, the present invention defines a process where key is generated using multiple factors, namely user-provided password/PIN, static handle provided by the host, a dynamic value received from the host during handshaking process, static physical characteristic of the user/computer/device, and dynamic physical characteristic of the user/computer/device. Use of multiple independent factors makes the probability of identity theft very low.

Thus, the present invention defines a process where the dynamic encryption key is based on the data held with the user and host computer. The knowledge of building and parsing the encryption key is known only to the client and server components. Thus, if a key is stolen it becomes very difficult for the hacker to decrypt the key and steal factors, making man-in-middle attack useless.

Thus, the present invention defines a process where the dynamic generated key keeps changing periodically. This period can be very short, in the order of few seconds. Thus, a key can not be stolen and used at a later time, making phishing and pharming useless.

Thus, the present invention defines a process where the dynamic generated key has a limited life and it expires after the defined time is past. Thus, if a key is stolen and used at a later time, the key might get rejected because it might have been expired. The chances of somebody trapping the key and reusing within a very short period is very difficult. Thus, making phishing and pharming useless.

Thus, the present invention defines a process comprising of an interface that accepts the key string and passes on to the host for authentication. The present process does not require any significant change in the user interface.

Thus, the present invention defines a process where the server software running on host computers accepts the key string value; extracts the encryption key from the key string, decrypts the key string based on the encryption key, evaluates the static factors against its database, and evaluates the dynamic factors based on pre-defined logic. Since the database of factors and pre-defined logic knowledge is available only with the host server, no host other than the target host can use the key successfully.

Thus, the present invention defines a process where based on the authentication results the host has total ability of allowing or denying the access.

Thus, the present invention defines a process where users can store user-id and optionally password in a secure database accessible only to the user. Thus, users do not have to remember many user-ids and passwords. In the absence of such facility there is a tendency of keeping the same user-id and password for many hosts, which is not secure.

What is claimed is:

1. A method of authenticating the identity of a user to determine access to a host, comprising: providing a generated key string based on multiple factor data instances; evaluating factor-based data instances to determine if the user's identity is authenticated; restricting the user's access to the host if the user's identity is not positively authenticated; and granting the user's access to the host if the user's identity is positively authenticated. These factors are categorized as:
1. Something you know—A piece of data that the user is likely to know, but is not generally known to be associated with the user
2. Something you have—A piece of data that the user possesses but not fully known to user and
3. Something you are—A physical characteristic associated with the user or his environment correlating with the user
A “user” can be any human being accessing web sites, remote computer or remote service either over the internet or intranet;
A “computer” can be any computer, device, PDA, wireless device supporting web access;
A “host” is a web site, remote computer or remote service that is serving users;
Physically users, remote computers, remote services, web sites, and authentication services providers can reside anywhere in the world.

2. The method of claim 1 allowing multi-factor authentication that can be deployed requiring minimum software or hardware that a typical user may already possess.

3. The method of claim 1 that is implemented using a client based or web based client component running on user's machine. Users do not have to carry any devices.

4. The method of claim 1 allowing a common authentication method for multiple hosts.

5. The method of claim 1 allowing multiple users to use the same piece of software/hardware.

6. The method of claim 1 allowing users to store user-id and optionally password/pin for multiple hosts in a secure format. Thus, users do not have to remember user-ids, password, pin for many hosts and they do not have to keep same user-id, password, or pin for many hosts.

7. The method of claim 1, further comprising providing at least one factor value, based on “Something you know” like password, PIN, zip code, phone number, Social Security number, account number, mother's maiden name, etc.

8. The method of claim 1, further comprising providing/gathering at least one factor value, based on “Something you have” like handle given by the system, registered device number, environment value, session id, transaction id, server time, hardware id given by the server to the user.

9. The method of claim 1, further comprising providing/gathering at least one factor value, based on “Something you are” like disk id or hardware id of the user's computer, IP address of user's computer, user computer's clock, user computer's Mac id, user computer's disk-id, user's signature, user's fingerprint, etc.

10. The method of claim 1, further comprising of a registration process during that the user's physical characteristics are registered with the system and the system in turn provides a unique handle that is stored on the user's computer/device. The handle is unique for a user and his/her computer.

11. The method of claim 1, further comprising of a process that allows storage of this data on a remote computer in case data is not allowed to be stored on user's computer.

12. The method of claim 1, further comprising of a registration process that allows multiple computers for a user to be registered with a host, where each registration is uniquely identified.

13. The method of claim 1, further comprising of a registration process that allows multiple users using the same computer to be registered with a host, where each registration is uniquely identified.

14. The method of claim 1, further comprising of a process where the handle allocated by the host is stored on user's computer or a remote computer in a secure format.

15. The method of claim 1, further comprising of a process where there is a handshake between the user computer and the host allowing host to dynamically allocated factors to the user's computer.

16. The method of claim 1, further comprising of a client software that generates an encrypted key string derived based on one or many of a user-provided password/PIN, static handle provided by the host, a dynamic value received from the host during handshaking process, static physical characteristic of the user/computer/device, and dynamic physical characteristic of the user/computer/device.

17. The method of claim 1, further comprising of a process where the dynamic encryption keys are based on the data held with the user and host computer. The knowledge of building the encryption key is known only to the client and server component.

18. The method of claim 1, further comprising of a process where the dynamic generated key keeps changing periodically, reducing the chances of theft. Typically the period is very short, in the order of few seconds. Also, the dynamic generated key has a limited life, thus becoming unusable after the life is over.

19. The method of claim 1, further comprising of a process where server software running on host computers that accepts the key string value; extracts the encryption key from the key string, decrypts the key string based on the encryption key, evaluates the static factors against its database, and evaluates the dynamic factors based on pre-defined logic.

20. The method of claim 1, further comprising of a process where hosts have total ability of allowing or denying accesses based on the authentication results.
